(19) United States
(12) Patent Application Publication
(10) Pub. No.: US 2026/0090640 A1
(43) Pub. Date: Apr. 2, 2026

(54) EJECTION DEVICE FOR A MOVABLE FURNITURE PART

(71) Applicant: Julius Blum GmbH, Hoechst (AT)

(72) Inventor: Christof GOETZ, Lustenau (AT)

(21) Appl. No.: 19/410,667

(22) Filed: Dec. 5, 2025

Related U.S. Application Data
(63) Continuation of application No. PCT/AT2024/060174, filed on Apr. 25, 2024.

(30) Foreign Application Priority Data
Jun. 7, 2023 (AT) A 50448/2023

(51) Int. Cl. A47B 88/463; A47B 88/473; E05B 65/46

(52) U.S. Cl. CPC A47B 88/463; A47B 88/473; E05B 65/46; A47B 2210/0091

(57) ABSTRACT

An ejection device for moving a movable furniture part from a closed position in the direction of an open position includes a housing, an ejection means movable relative to the housing for transmitting force from the ejection device to the movable furniture part in the opening direction, an energy storage device for applying force to the ejection means, and a locking device for inhibiting movement of the ejection means in a locking position of the locking device in the direction of the open position. The ejection means comprises a release means separate from the locking device and the ejection means for contacting and/or interacting with the locking device, wherein the at least one release means is arranged on the ejection means.

The present application is a continuation of International Application PCT/AT2024/060174 filed on Apr. 25, 2024. Thus, all of the subject matter of International Application PCT/AT2024/060174 is incorporated herein by reference.

### BACKGROUND OF THE INVENTION

The invention relates to an ejection device for a movable furniture part for moving the movable furniture part from a closed position in the direction of an open position, comprising a housing, an ejection means movable relative to the housing for transmitting force from the ejection device to the movable furniture part in the opening direction, an energy storage device for applying force to the ejection means, and a locking device for inhibiting movement of the ejection means in a locking position of the locking device in the direction of the open position. Furthermore, the invention relates to a piece of furniture having at least one such ejection device. Furthermore, the invention relates to a method for operating such an ejection device.

An ejection device for movable furniture parts is already known from document WO 2011/015663 A2, wherein a locking device is guided in a guide track. If the locking device is guided into an inclined plane of the locking device by an ejection means, the ejection means is unlocked. A damper or an elastic stop for the movable furniture part prevents the ejection device from being over-pressed.

A disadvantage of the prior art is that at high speeds of the movable furniture part in the closing direction, the damper designed for self-retraction and the elastic stop intended to fix the closed position of the movable furniture part pose a risk of the movable furniture part being unintentionally ejected.

### SUMMARY OF THE INVENTION

The object of the present invention is therefore to provide an ejection device which is improved in comparison with the prior art, in which the disadvantages of the prior art are at least partially eliminated, and which is characterized in particular by a secure locking position of the locking device and/or a comfortable unlocking of the locking device.

According to the invention, the ejection means comprises at least one release means separate from the locking device and the ejection means for contacting and/or interacting with the locking device, wherein the at least one release means is arranged on the ejection means. This makes it possible to generate a push-through protection via the at least one release device, which, depending on the movement trajectory and/or the movement speed of the ejection means, can ensure a locking or unlocking of the ejection means. Unwanted ejection during desired locking can be effectively prevented despite high accelerations of the movable furniture part.

As stated at the beginning, protection is also sought for a piece of furniture comprising a furniture body, at least one furniture part movable relative to the furniture body and at least one such ejection device.

As stated at the outset, protection is also sought for a method for operating such an ejection device, wherein the following steps are carried out:
starting from the open position, the ejection means is moved together with a control device and the at least one release means into the closed position
starting from the closed position, the ejection means is moved together with the at least one release means into an overpressure position
the ejection means is moved back from the overpressure position in the direction of the closed position together with the at least one release means, wherein the at least one release means is pivoted in a direction orthogonal to the opening direction, in particular in a damped manner, so that the at least one release means contacts the locking device in the closed position and movement of the ejection means together with the control device and the at least one release means in the direction of the open position is inhibited by means of the locking device in the locking position.

### BRIEF DESCRIPTION OF THE DRAWINGS

Features of individual embodiments of the ejection device may be applicable to the other embodiments of the ejection device. Further details and advantages of the present invention will be explained in more detail below with reference to the drawings, in which:

FIG. 1 is a perspective view of a piece of furniture with movable furniture parts in the form of drawers, which can be ejected from a furniture body by an ejection device according to the invention,

FIGS. 2a-2g are sectional views of an ejection device according to a preferred embodiment in the region of a locking device in a top view,

FIGS. 3a-3f are a detailed section and section view of the ejection device according to the exemplary embodiment shown in FIG. 2a with the housing mounted,

FIGS. 4a, 4b are perspective and plan views of an ejection device according to a further preferred embodiment,

FIGS. 5a-5f are detailed section views of the ejection device according to the exemplary embodiment shown in FIG. 4a with component parts visualized below the housing in the region of the locking device,

FIGS. 6a, 6b are perspective and plan views of an ejection device according to a further preferred embodiment,

FIGS. 7a-7e are top views of the ejection device according to the exemplary embodiment shown in FIG. 6a with the housing side wall removed,

FIGS. 8a, 8b are perspective and plan views of an ejection device according to a further preferred embodiment,

FIGS. 9a-9d are sectional views of the ejection device according to the exemplary embodiment shown in FIG. 8a in the region of the locking device,

FIGS. 10a-10e are plan views of the ejection device according to the exemplary embodiment shown in FIG. 9a with the housing side wall removed,

FIG. 11 is a perspective view of another piece of furniture with a removed drawer and two ejection devices connected by a synchronization shaft according to a further preferred embodiment, and

FIGS. 12a-12f are plan and sectional views of the ejection devices according to the exemplary embodiment according to FIG. 12f in the region of the locking device.

### DETAILED DESCRIPTION OF THE INVENTION

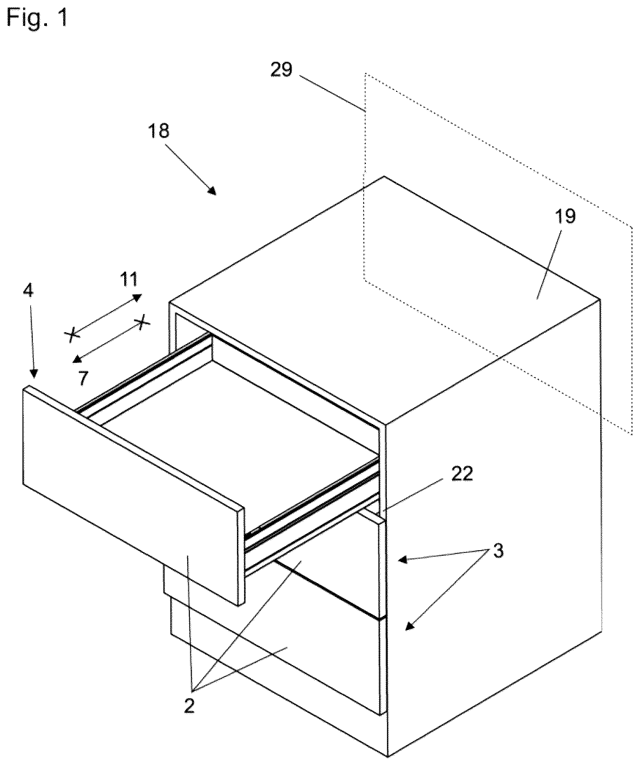

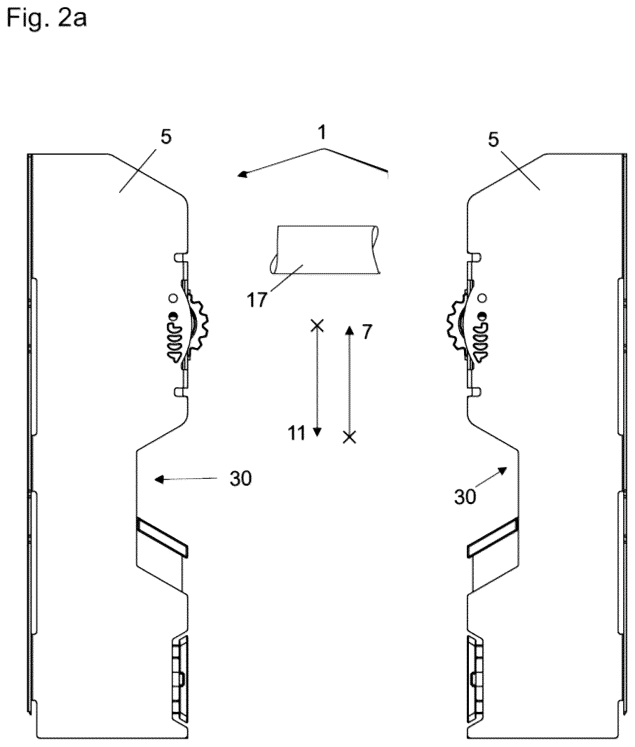

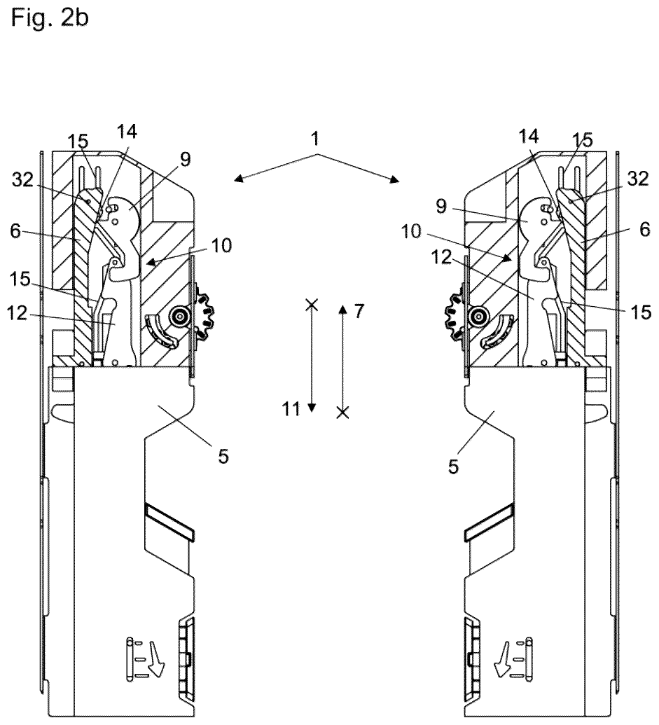

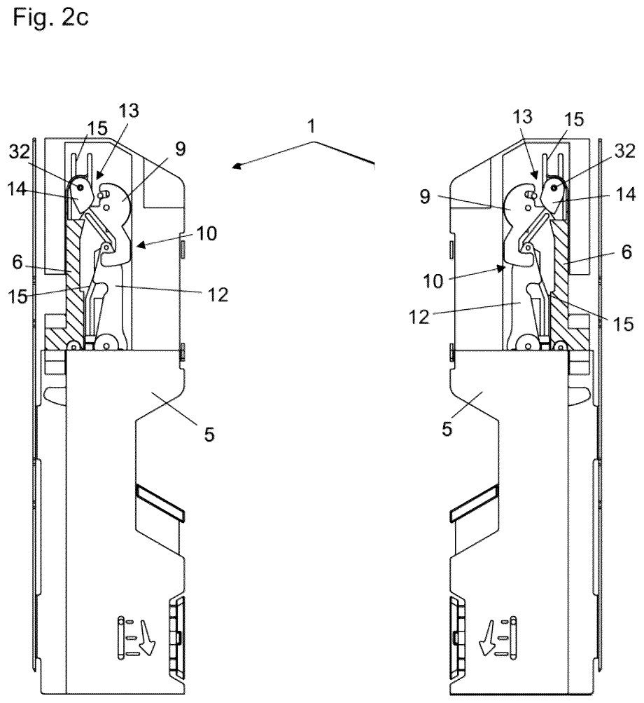

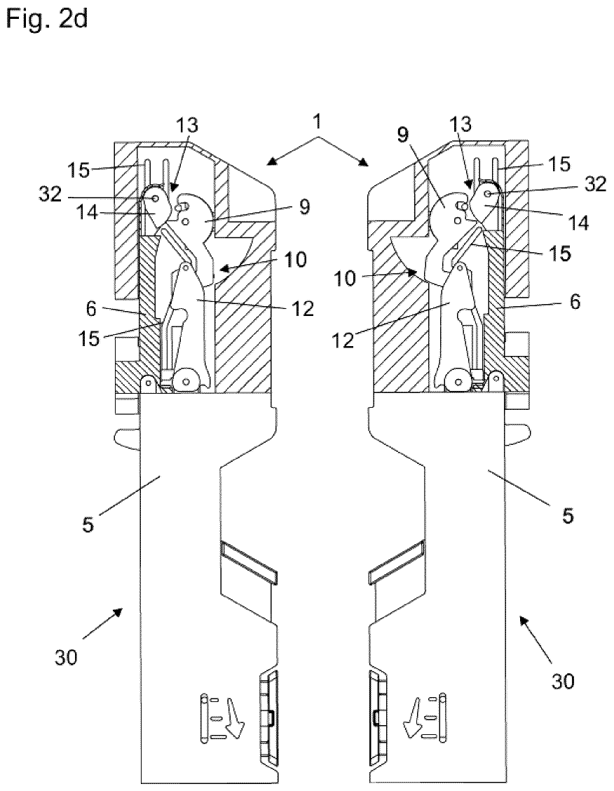

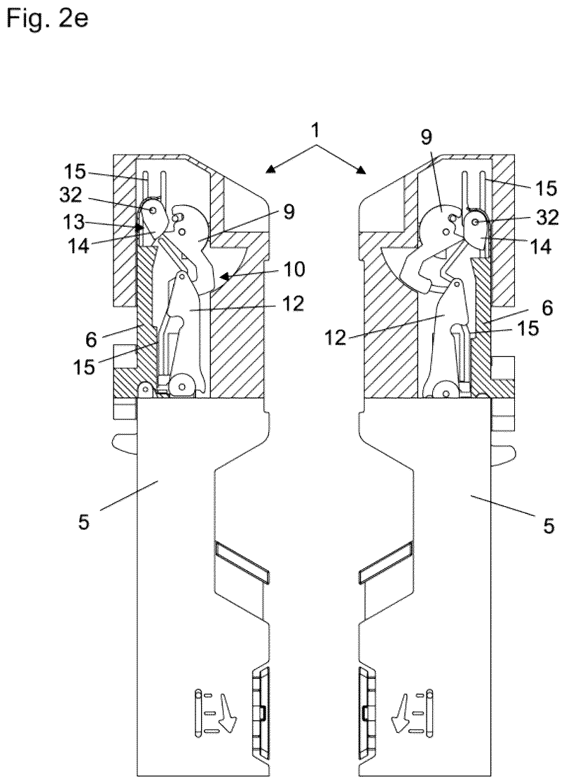

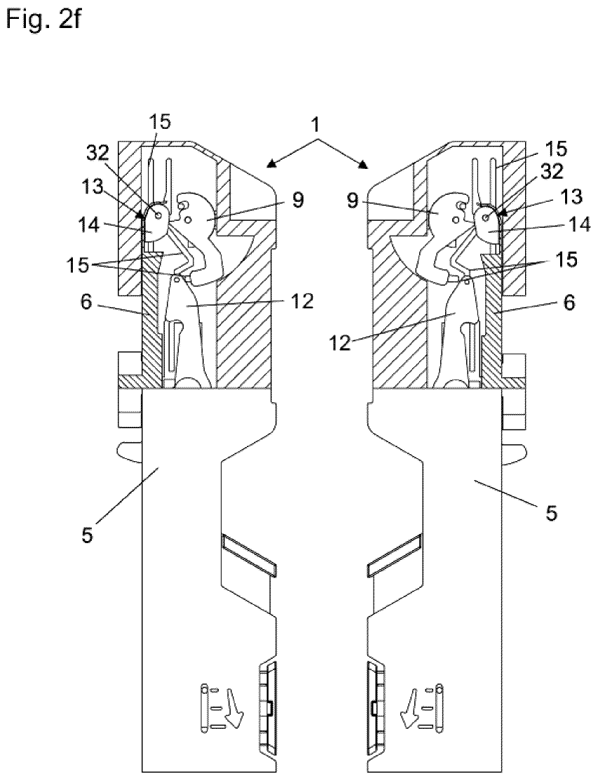

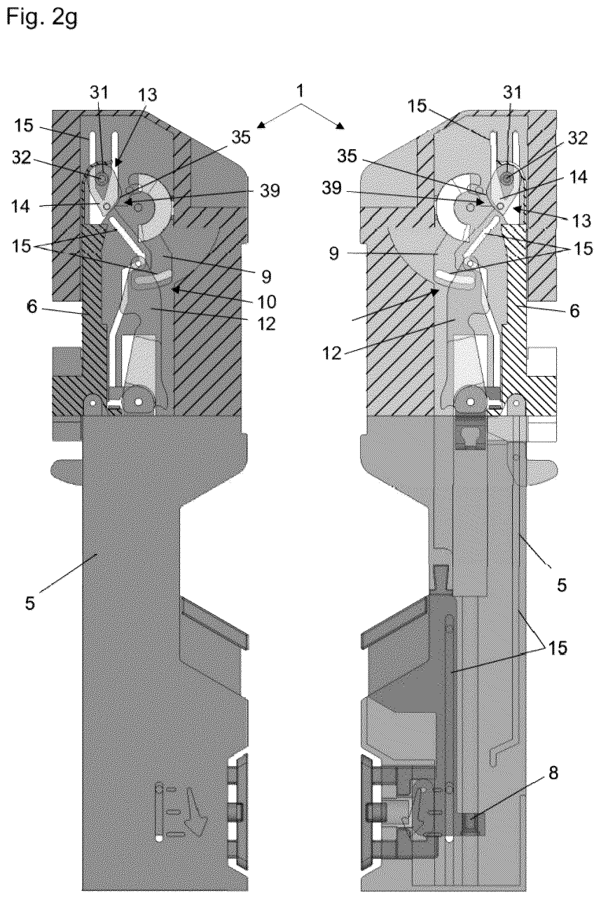

FIG. 1 shows a piece of furniture 18 comprising a furniture body 19, three furniture parts 2 in the form of drawers that are movable relative to the furniture body 19 and (concealed by the drawers) two ejection devices 1 for ejecting the drawer. The two ejection devices 1 (not shown for clarity) are arranged essentially mirror-symmetrically on the furniture body 19 (see FIG. 2a).

A first locking device 9 and a second locking device 9 can be unlocked essentially in a plane 29 oriented parallel to the furniture body 19 (synchronously or asynchronously) and be designed in the same way.

The methods and arrangements set out below for the piece of furniture 18 are applicable to all embodiments of the ejection devices 1.

Preferably, the movable furniture part 2 is in the form of a drawer, with the ejection device 1 being particularly preferably arranged below the drawer. In general, the application is possible with other movable furniture parts 2—such as flaps or the like—or an arrangement to the side of the movable furniture part 2.

The ejection device 1 is fixed to a guide device for the movable furniture part 2, which preferably comprises a body rail for attachment to the furniture body 19, a drawer rail and optionally a center rail.

FIG. 2a shows the ejection devices 1 with mounted housing 5 and a schematically indicated synchronization shaft 17, which may generally be provided (in order to achieve synchronous unlocking and not asynchronous unlocking of the locking device 9, which is generally present without a synchronization shaft 17) or can be retrofitted via an optional interface, but is not absolutely necessary for functioning on the movable furniture part 2.

For example, by applying pressure to a central region of a furniture front of the movable furniture part 2, both ejection devices 1 can be released by exerting pressure. If only a locking device 9 is unlocked by the pressure actuation—in particular by a lateral pressure actuation on the movable furniture part 2—then wedging of the movable furniture part 2 is prevented by the function of the bidirectional unlocking via a separate release means 13.

A synchronization shaft 17 is not required for the arrangement of a movable furniture part 2 and two ejection devices 1 in order to properly eject the movable furniture part 2 from the furniture body 19 (despite off-center pressure being applied to the movable furniture part 2).

FIG. 2b shows the ejection devices 1 in sectional view, wherein the ejection device 1 for the movable furniture part 2 comprises, for moving the movable furniture part 2 from a closed position 3 in the direction of an open position 4, an ejection means 6 movable relative to the housing 5 for transmitting force from the ejection device 1 to the movable furniture part 2 in the opening direction 7, a energy storage device 8 for applying force to the ejection means 6, and a locking device 9 for inhibiting movement of the ejection means 6 in a locking position 10 of the locking device 9 in the direction of the open position 4.

The ejection devices 1 each comprise a control device 12 for force transmission from the energy storage device 8 to the ejection means 6, wherein a movement of the control device 6 in the direction of the open position 4 in the locking position 10 of the locking device 9 can be inhibited.

Both ejection devices 1 shown are located in a locking position via the locking devices 9 in interaction with the control devices 12, so that a movement of the ejection means 6 in the direction of the open position 4 of the movable furniture part 2 is blocked.

The locking device 9 can be unlocked via the ejection means 6 both by applying pressure to the ejection means 6 in the closing direction 11 (corresponding to the closing direction 11 of the movable furniture part 2 in the operating position) and by pulling on the ejection means 6 in the opening direction 7 (corresponding to the opening direction 7 of the movable furniture part 2 in the operating position), so that the ejection means 6 can be released in the opening direction 7 in order to eject the movable furniture part 2 from the furniture body 19.

FIG. 2c shows the ejection devices 1 in a sectional view offset from FIG. 2b, showing that the ejection means 6 comprises a release means 13 in the form of a pivotable lever 14, which is subjected to force relative to the ejection device 6, for contacting and interacting with the locking device 9.

The release means 13 represents a component separate from the locking device 9 and the ejection means 6 for unlocking and/or locking the ejection means 6 via the locking device 9.

The release means 13 is associated with a particularly high release range of the ejection device 1, wherein a release lock is implemented in the locking mechanism-due to the relative positioning (in particular the arrangement of the release means 13 on the ejection means 6) and mobility of the structural components (in particular the guide track 15, to form a push-through protection). This ensures high functionality and flexible use of the ejection device 1.

The ejection devices 1 generate only a low noise in connection with the ejection movement of the movable furniture part 2, despite the bidirectional unlocking capability and a possible asynchronicity in the unlocking of the second locking device 9 during an opening movement of the movable furniture part 2—generally mediated by an opening dynamic of the movable furniture part 2—thus ensuring a high level of user comfort for a user of the movable furniture part 2.

The ejection means 6 is movable relative to the locking device 9 in the closing direction 11, wherein the locking device 9 can only be unlocked by a movement of the ejection means 6 in the opening direction 7.

FIG. 2d shows, in the case of the right ejection device 1 (in contrast to the left ejection device 1), a pivoted position of the lever 14 relative to the locking device 9, in which an unlocking of the locking device 9 by pulling can be caused by the energy storage device 8 (covered by the lower region of the housing 5).

The release means 13 is provided for contacting and interacting with the locking device 9, wherein the release means 13 is arranged on the ejection means 6.

In FIG. 2e it can be seen that the locking device 9 is pivotable for unlocking in order to release the control device 12 and the ejection means 6 via the lever 14.

The right ejection device 1 is already unlocked for ejection, while the left ejection device 1 is not yet activated.

In FIG. 2f the ejection movement is already advanced, wherein by the ejection movement of the right ejection device 1 also the left ejection device 1 was unlocked via a force transmission from the lever 14 to the locking device 9.

The right ejection device 1 was unlocked by pushing action and the left ejection device 1 was unlocked by pulling action, in order to release the respective ejection means 6.

FIG. 2g shows the ejection devices 1, with the component parts located inside the housing 5—in particular the energy storage device 8 connected to an adjustment device—being visualized on the right.

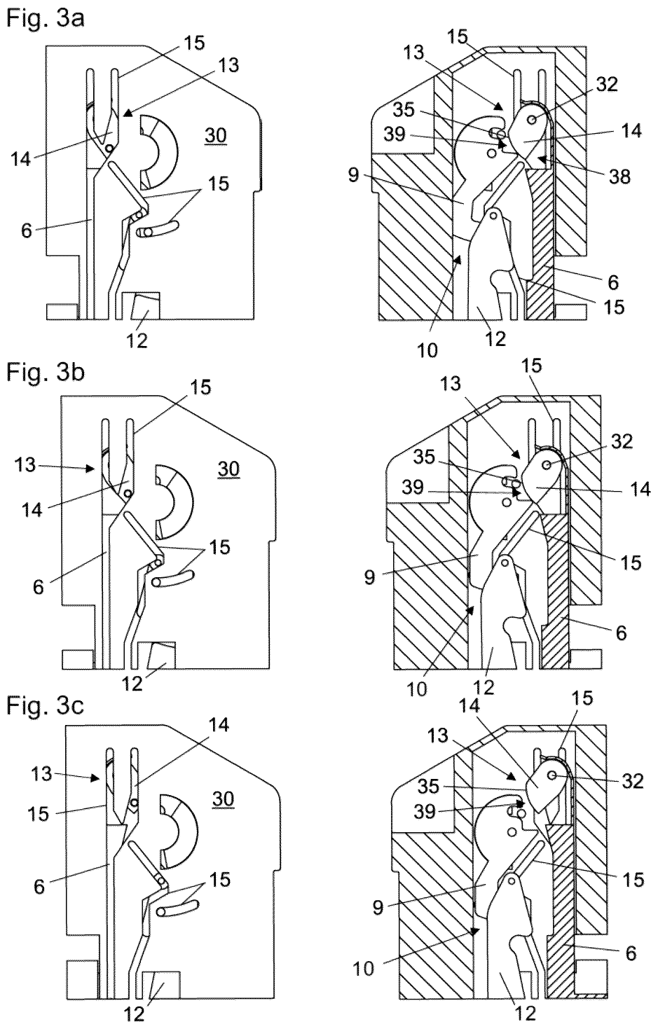

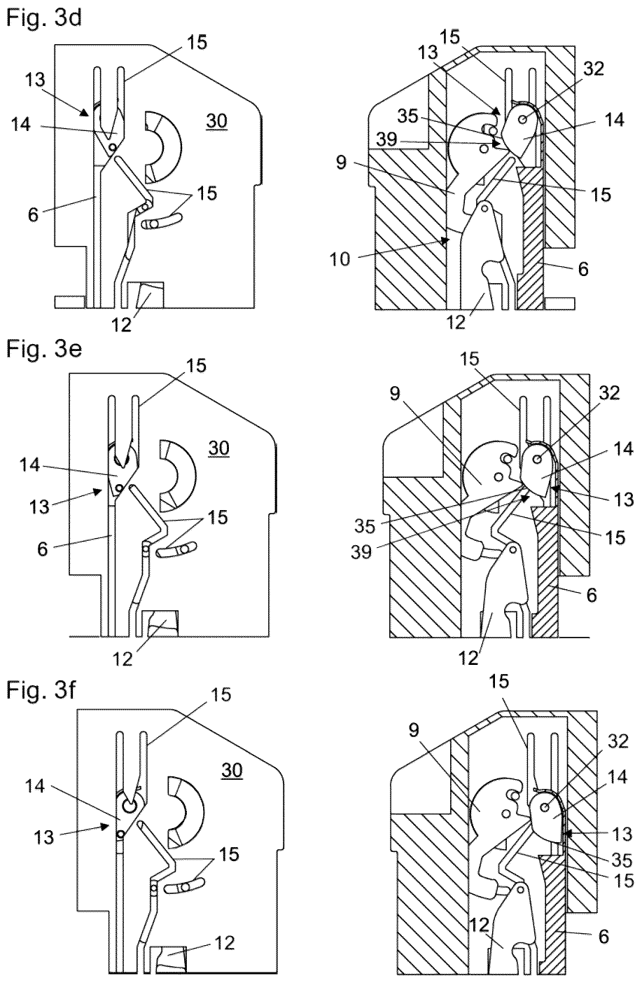

FIGS. 3a to 3f show the region relevant for unlocking the ejection device 1 in an enlarged view during the activation of the ejection means 6 in the course of an overpressure movement (a pure pulling movement to release the ejection means 6 is also possible).

The release means 13 is pivotably arranged on the ejection device 1 and comprises a contact contour 35 as a contact surface, with which the locking device 9 can be contacted in two separate contact positions 37, 38.

The contact contour 35 is curved to transmit variable forces to the locking device 9 when the pivoted position of the lever 14 is changed, and has a knurling 39 to prevent unwanted slippage when the ejection means 6 is locked as desired.

The ejection means 6, the energy storage device 8, the control device 12, the locking device 9 and the release means 13 are guided in guide tracks 15 of the housing 5.

The ejection means 6 is arranged partly outside and partly inside the housing 5, wherein the energy storage device 8, the control device 12, the locking device 9 and the release means 13 are arranged inside the housing 5.

The ejection devices 1 are designed without a synchronization shaft, wherein in general an interface 16 for connecting a synchronization shaft 17 for synchronizing the ejection device 1 with another ejection device 1 may be provided.

An exemplary method for ejecting the movable furniture part 2 from the closed position 3 in the direction of the open position 4 relative to the furniture body 19 by means of two ejection devices 1 can be explained as follows:
the first ejection means 6 of the first ejection device 1 of the two ejection devices 1 is moved by pressure on the movable furniture part 2 in the closing direction 11 from the closed position 3 into an overpressure position 22,
the first energy storage device 8 of the first ejection device 1 moves the first ejection means 6 in the direction of the open position 4, so that the first locking device 9 of the first ejection device 1 is unlocked and the first ejection means 6 is moved in the opening direction 7,
the movable furniture part 2 is moved by the first ejection means 6 in the opening direction 7, so that the second ejection means 6 of the second ejection device 1 of the two ejection devices 1 is moved in the opening direction 7,
the second locking device 9 of the second ejection device 1 is unlocked by means of pulling on the second ejection means 6 in the opening direction 7 without a synchronization shaft, so that the second energy storage device 8 of the second ejection device 1 transmits force to the second ejection means 6 and the movable furniture part 2 is subjected to force in the direction of the open position 4.

Thus, the first locking device 9 and the second locking device 9 can be unlocked asynchronously (or synchronously) from their respective locking positions 10 (by pushing the first ejection means 6 and then pulling the second ejection means 6).

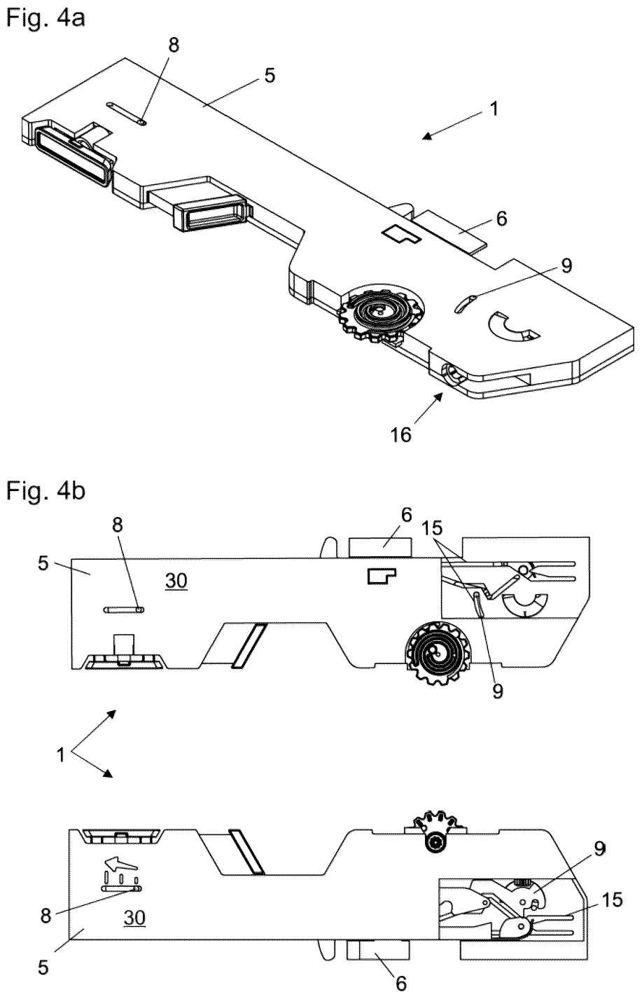

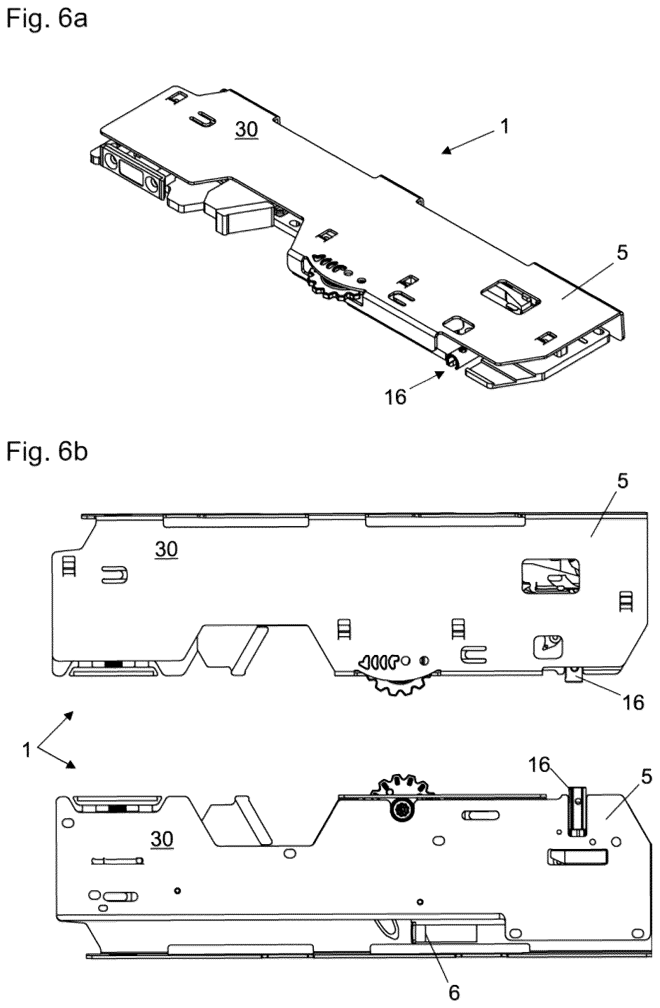

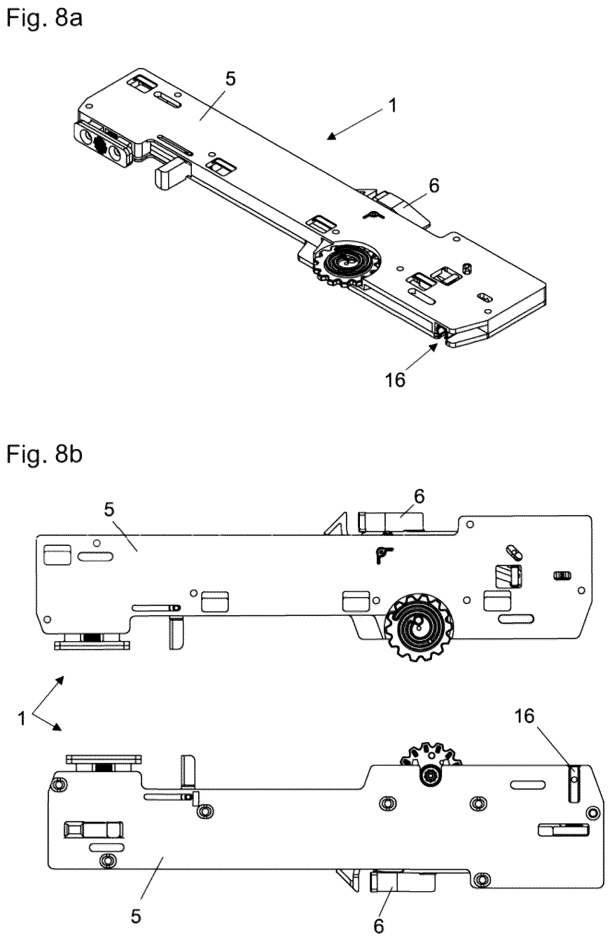

FIGS. 4a, 6a and 8a show further preferred embodiments of an ejection device 1 in perspective view.

FIGS. 4b, 6b and 8b show that the ejection device 1 comprises the housing 5, the ejection means 6, the energy storage device 8, the control device 12 and the locking device 9.

The ejection device 1 comprises the release means 13, wherein
the ejection means 6 comprises the release means 13 for contacting and interacting with the locking device 9, wherein the release means 13 is arranged on the ejection means 6.

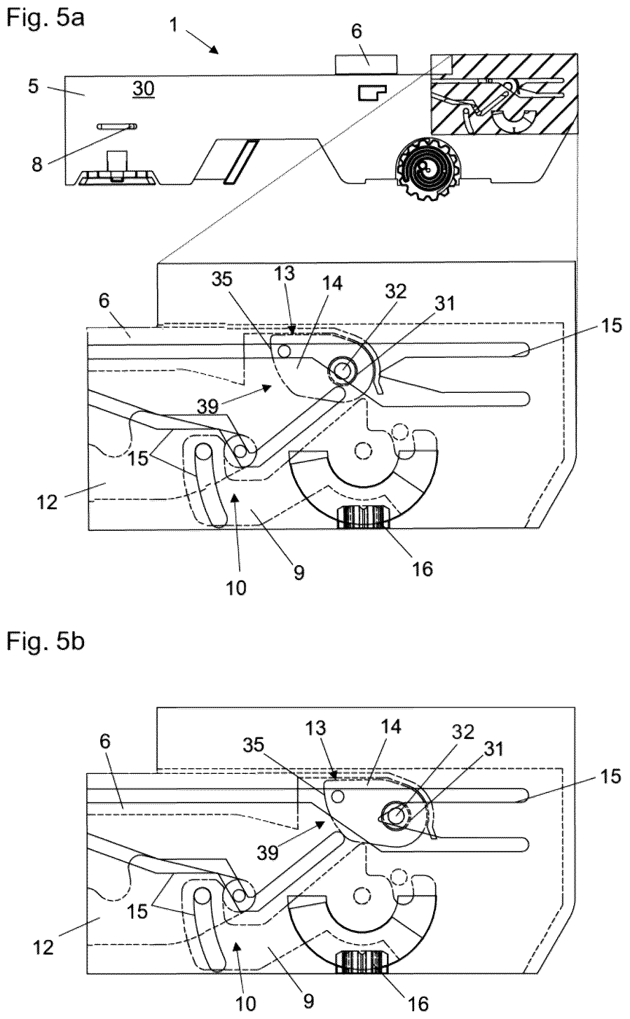

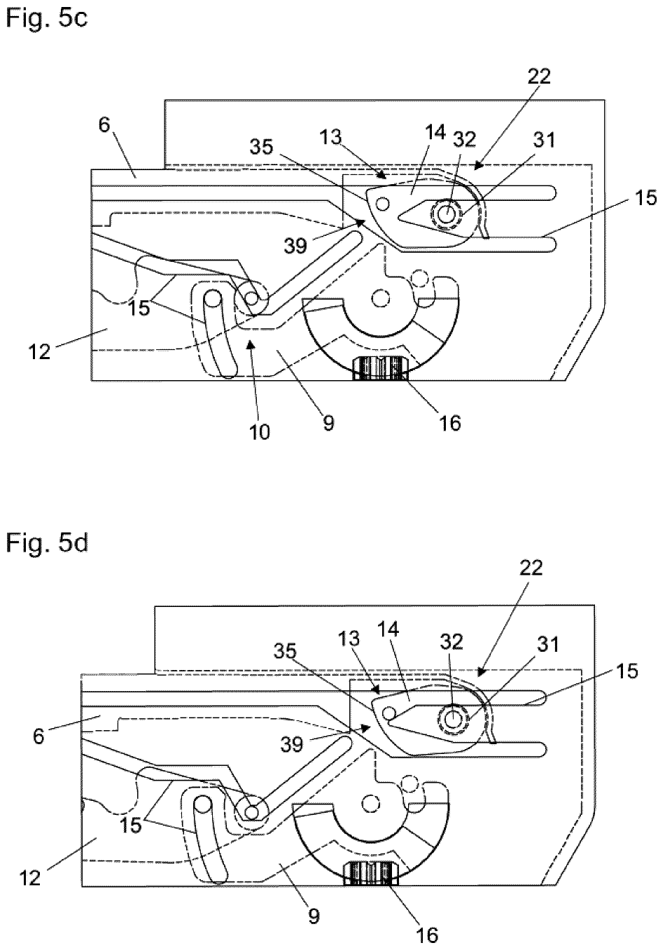

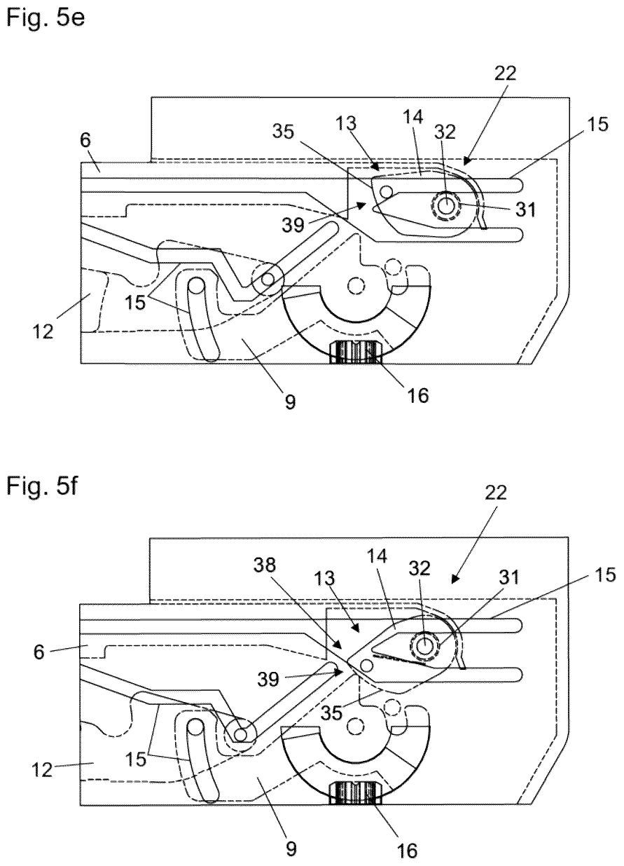

In FIG. 5a, the enlarged detail section of the ejection device shows that the release means 13 is arranged directly on the ejection means 6, partially within the ejection means 6 and directly between the ejection means 6 and a housing side wall 30 of the housing 5.

The release means 13 comprises a damping device 31 in the form of a rotary damper (wherein the specific design of the damping device 31 is irrelevant), with which a rotation of the release means 13 about a rotation axis 32 arranged on the ejection means 6 can be damped.

The damping device 31 forms a time element for the contacting of the locking device 9 by the release means 13 and can be provided as push-through protection for the ejection means 6 of the ejection device 1 in conjunction with an overpressure position 22.

The damping device 31 is arranged directly on and in the ejection means 6.

FIGS. 5b to 5f show different positions of the release means 13, which is in the form of the pivotable lever 14 which is subjected to force relative to the ejection means 6.

The release means 13 is pivotably arranged on the ejection device 1 and comprises the contact contour 35 formed by the contact surface, which is curved and provided with the knurling 39, with which the locking device 9 can be contacted in two separate contact positions 37, 38.

The locking device 9 can be unlocked via the ejection means 6 by applying pressure to the ejection means 6 in the closing direction 11 or by pulling on the ejection means 6 in the opening direction 7, so that the ejection means 6 can be released in the opening direction and to ensure an ejection of the movable furniture part 2 from the furniture body 19.

Starting from FIG. 5a, the ejection means 6 in FIG. 5b was moved in the closing direction 11, so that the lever 14 contacts the locking device 9 in the locking position 10. In FIGS. 5c and 5d, the ejection means 6 was moved into an overpressure position 22, wherein the lever 14 automatically pivots downwards about the axis of rotation 32 by force exerted by the spring (and damped via the damping device 31).

In FIG. 5e, the lever 14 is deflected in the guide track 15 over the overpressure position 22 in such a way that, when the ejection means 6 moves in the opening direction 7, the lever 14 contacts the locking device 9 via the contact contour 35 in such a way that the locking position 10 would be restored. In contrast, in FIG. 5f the lever 14 in the guide track 15 can pivot freely downwards in a damped manner across the overpressure position 22 (this is generally not an absolute necessity), so that when the ejection means 6 moves in the opening direction 7, the lever 14 contacts the locking device 9 via the contact contour 35 in such a way that the locking device 9 is unlocked by sufficient force transmission to the locking device 9.

According to FIGS. 5e and 5f, a push-through protection is implemented in the ejection device 1. If the movable furniture part 2 is moved at high speed in the closing direction 11, the lever 14 is maneuvered via a guide pin into the upper section of the guide track 15, as shown—the push-through track of the overpressure position 22—so that when the ejection means 6 is subsequently moved in the opening direction 7, the lever 14—by force applied via a spring connected to the ejection means 6 and via the damping device 31—contacts the locking device 9 at a first contact position 37 in order to set a locking position 10 and to prevent unwanted ejection. If ejection of the movable furniture part 2 from the locking position 10 is desired, the lever 14 is moved from the locking position 10 into the lower section of the guide track 15, as shown—the unlocking track of the overpressure position 22—wherein the lever 14 has sufficient time to contact the locking device 9 at a second contact position 38 during the return movement of the ejection means 6 in the opening direction 7. At the second contact position 38, there is a force ratio which is sufficient to unlock the locking device 9 and thus to release the ejection means 6.

An exemplary method for operating the ejection device 1 can be explained as follows:
starting from the open position 4, the ejection means 6 is moved together with the control device 12 and the release means 13 into the closed position 3
starting from the closed position 3, the ejection means 6 is moved together with the release means 13 into an overpressure position 22
the ejection means 6 is moved back from the overpressure position 22 in the direction of the closed position 3 together with the release means 13, wherein the release means 13 is pivoted in a damped manner in a direction orthogonal to the opening direction 7, so that the release means 13 contacts the locking device 9 in the closed position 3 and a movement of the ejection means 6 together with the control device 12 and the release means 13 is inhibited by the locking device 9 in the locking position 10 in the direction of the open position 4.

The locking position 10 can be released by pulling on the ejection means 6 or by an overpressure movement of the ejection means 6.

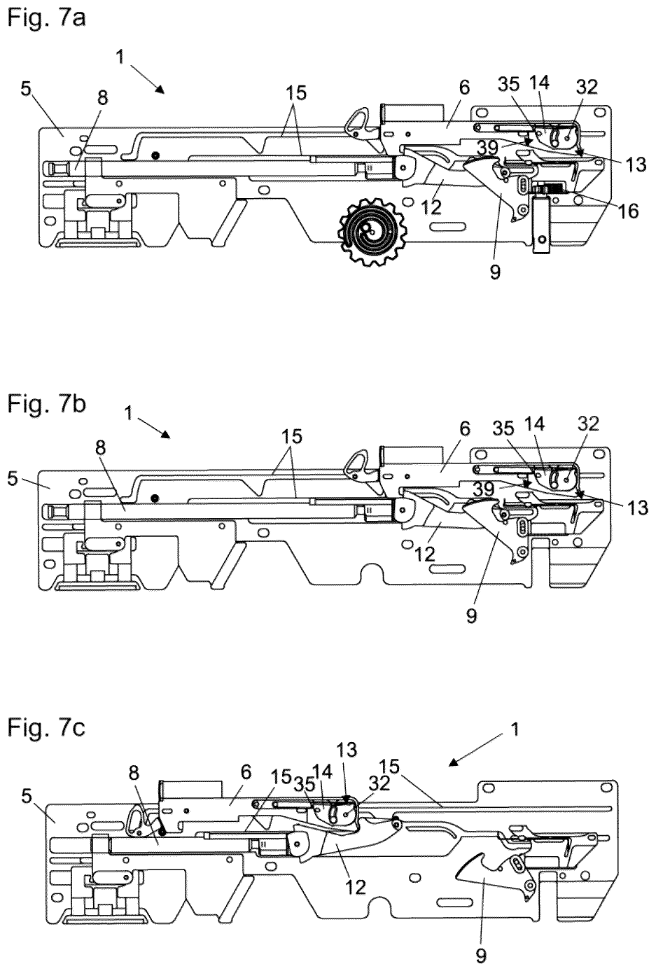

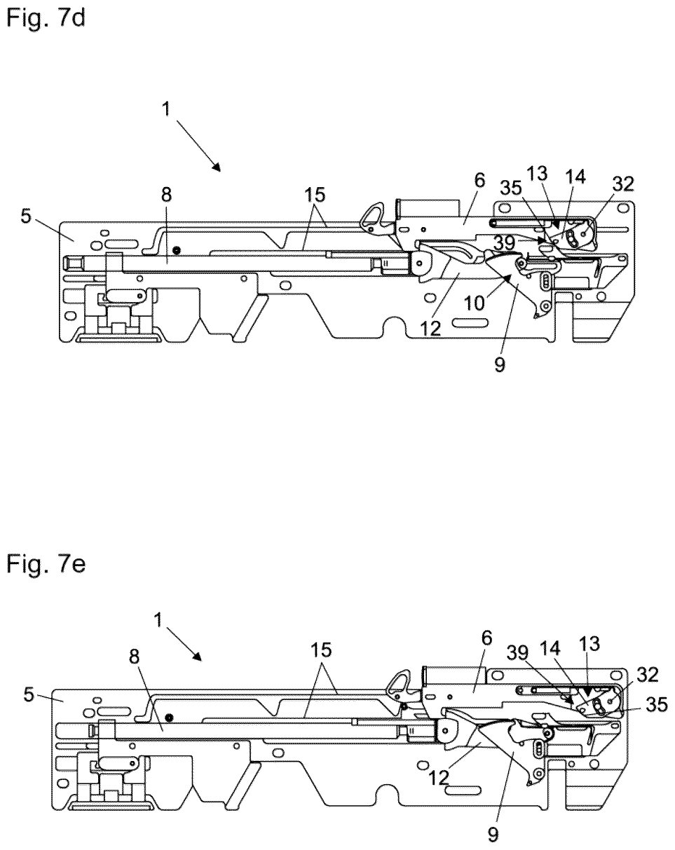

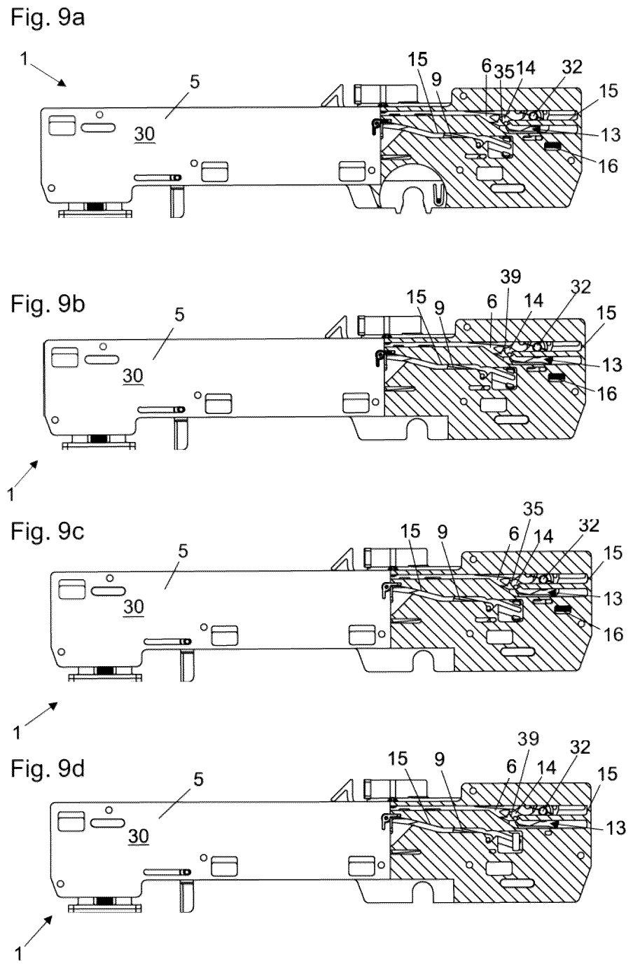

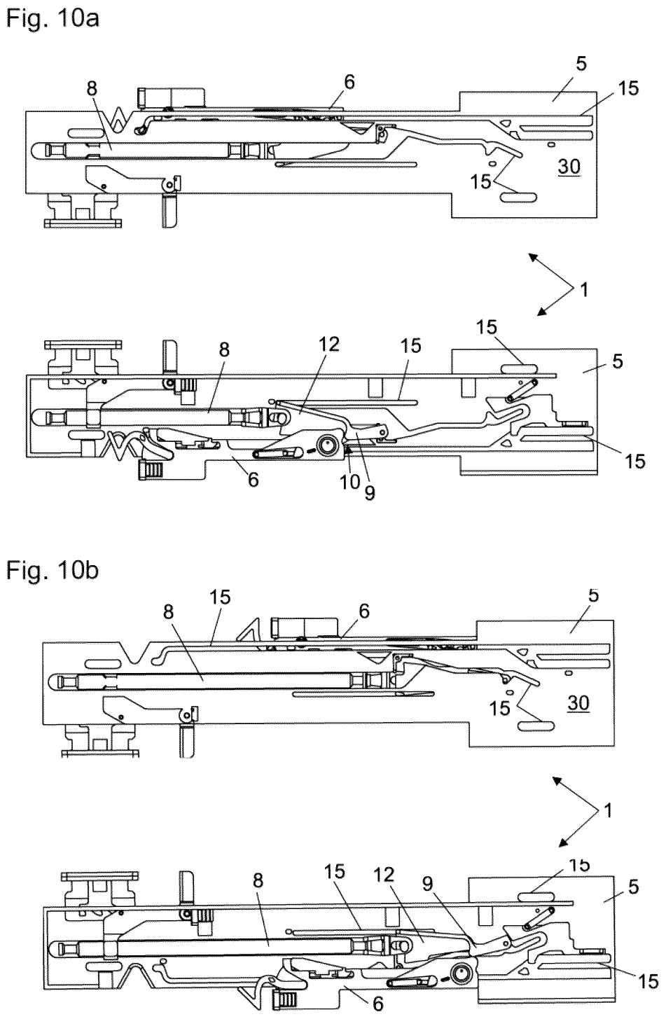

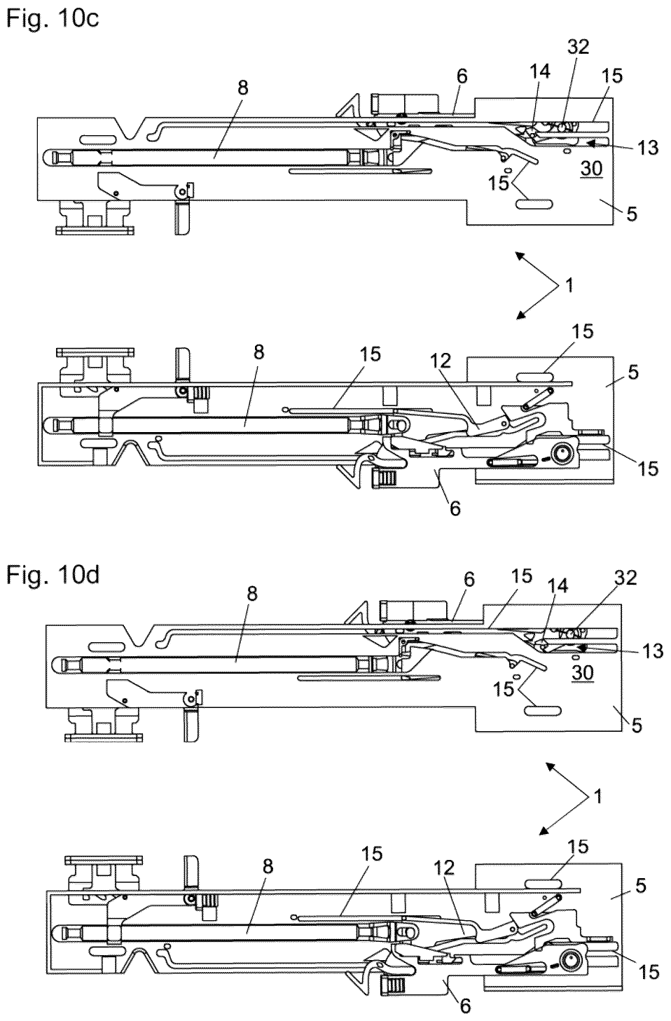

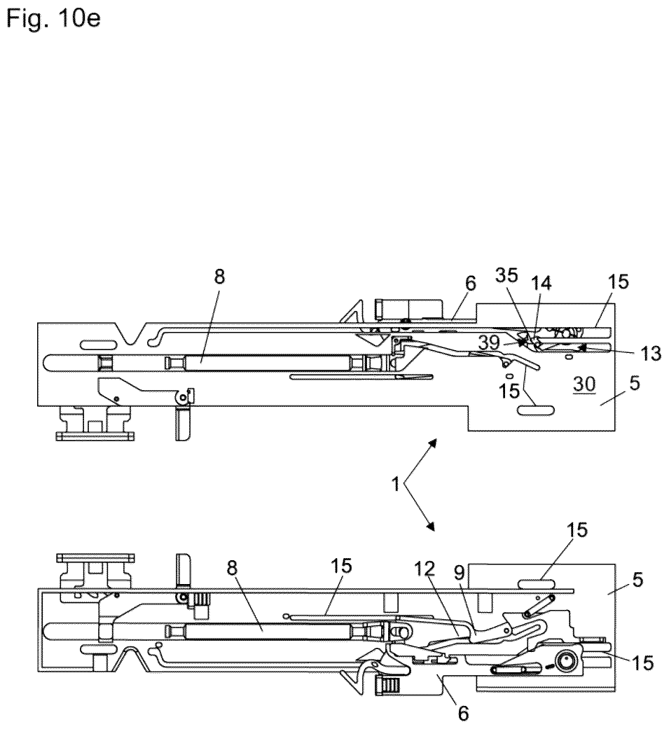

FIGS. 7a to 7e and FIGS. 9a to 9d as well as FIGS. 10a to 10e illustrate the kinematic interaction of the component parts of the ejection device 1 involved in locking and unlocking in alternative design configurations and analogous locking and unlocking mechanisms for the function of the ejection device 1. For example, the locking device 9 can be designed as a pivotable unlocking lever or as an incline of the guide track 15. For example, the energy storage device 8 can be reset via a linear release slide, a rotatably mounted reset device actuated by a leaf spring, or a combination thereof.

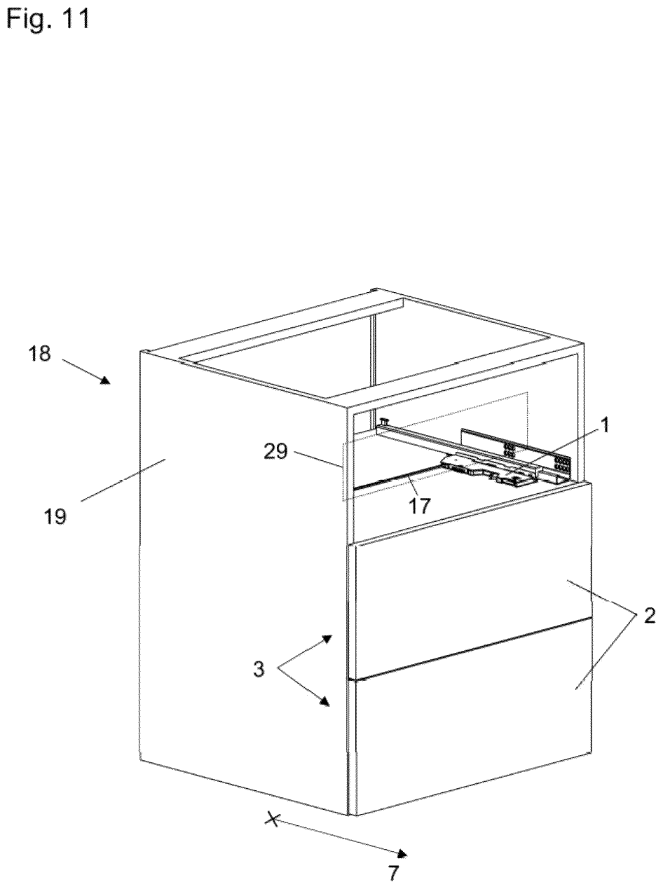

FIG. 11 shows a piece of furniture 18 with three movable furniture parts 2 which are movable relative to the furniture body 19, wherein one movable furniture part 2 has been removed to expose the ejection device 1.

Opposite the visible ejection device, a second, mirror-symmetrical ejection device 1 is arranged on the furniture body 2.

This embodiment of the ejection device 1 also comprises the housing 5, the ejection means 6, the energy storage device 8, the control device 12 and the locking device 9 as well as the release means 13.

The ejection device 1 can be modularly connected to a guide system for the movable furniture part and/or retrofitted as an add-on to the guide system.

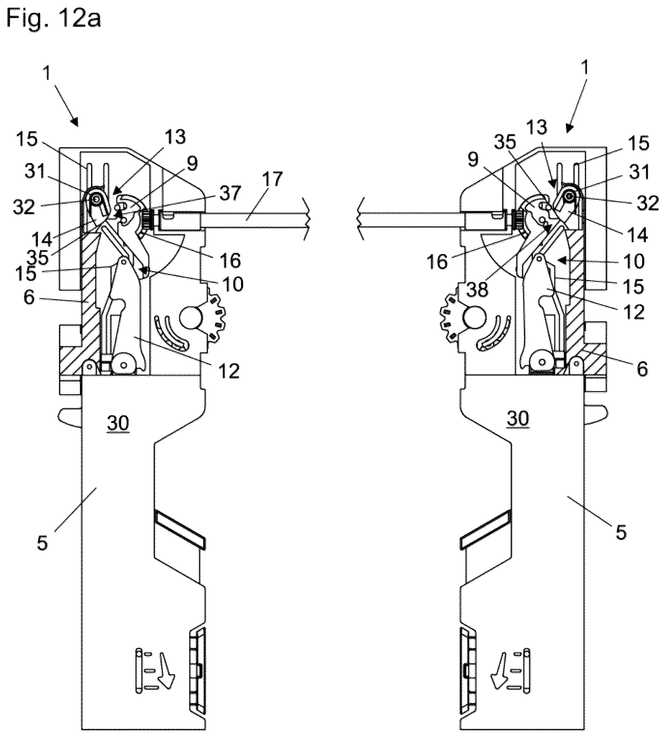

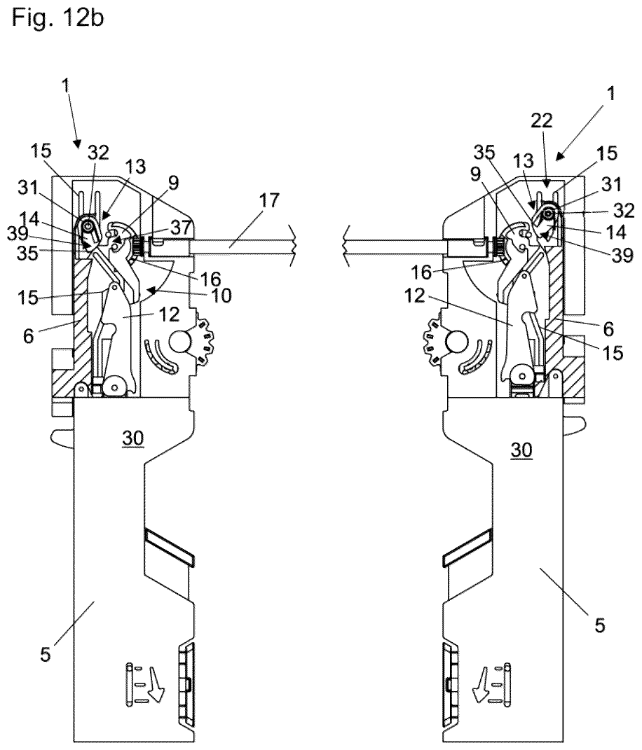

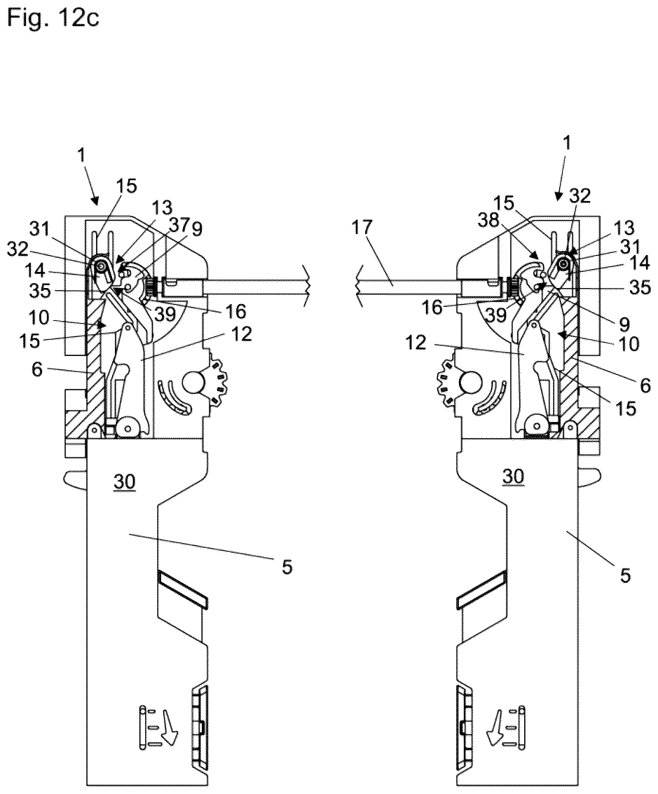

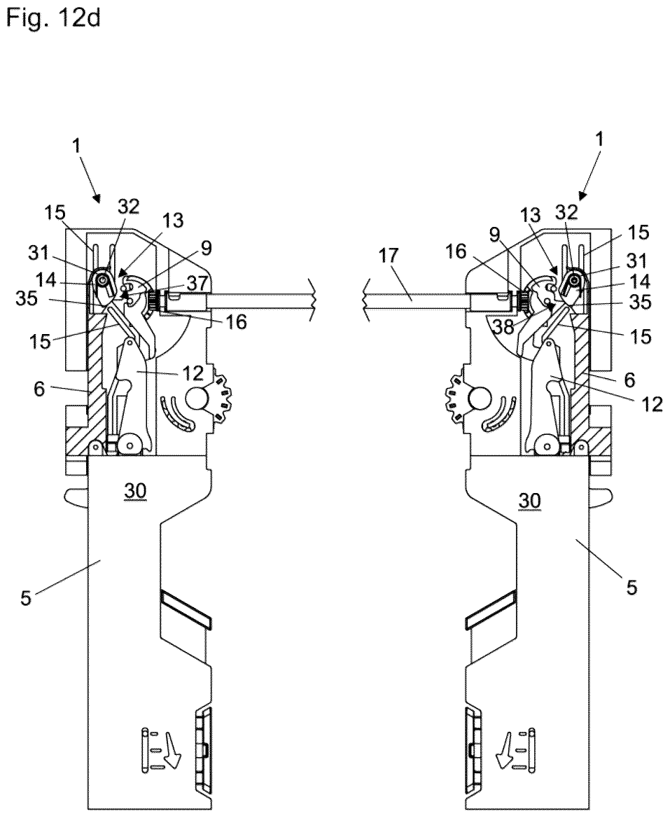

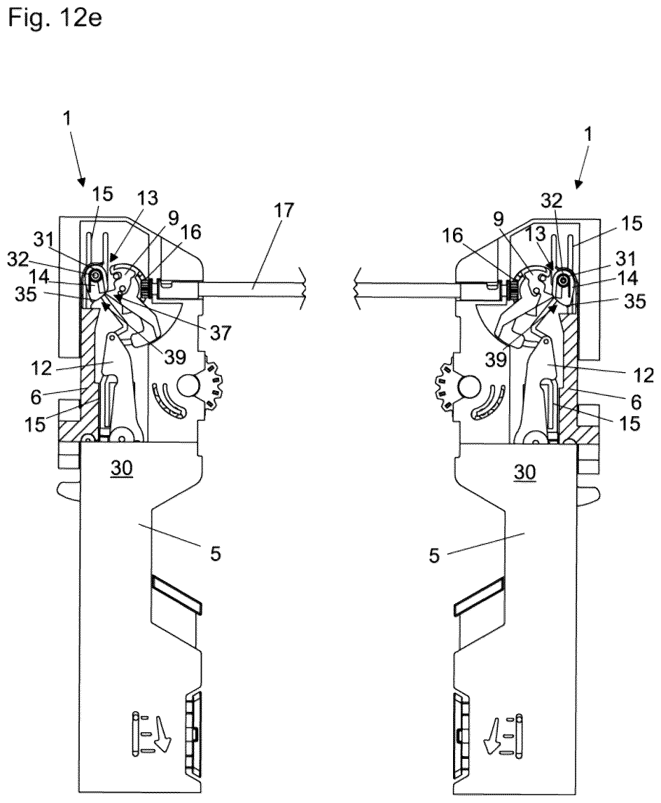

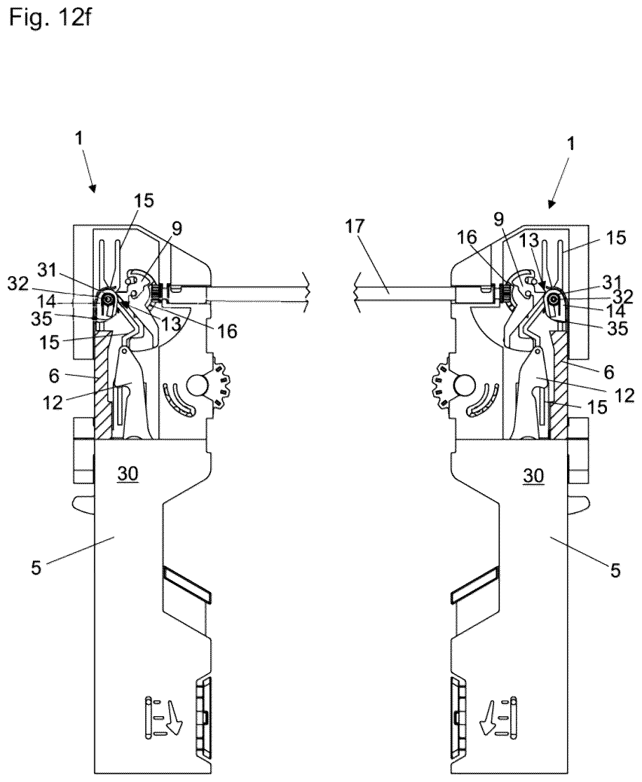

FIG. 12a shows that the ejection device 1 comprises the release means 13 for direct contacting of the locking device 9, wherein indirect contacting is also generally conceivable.

The release means 13 is pivotably arranged on the ejection device 1 and comprises a contact contour 35, with which the locking device 9 can be contacted in two separate contact positions 37, 38 for maintaining the locking position 10 or for unlocking the locking device 9.

The contact contour 35 is curved and has serrations in the form of a knurling 39, with the release means 13 in the form of the pivotable and force-actuated lever 14 being directly fastened to the ejection means 6.

As with the other embodiments of the ejection device 1, a damping device 31 is generally provided for the release means 13, which acts as a timing element for the lever 14, and the ejection device 1 can be unlocked by pulling and pushing without the mandatory requirement of a synchronization shaft 17.

In this exemplary embodiment, an arrangement consisting of two ejection devices 1 and a synchronization shaft 17 is provided for synchronizing the two ejection means 6 of the two ejection devices 1.

The two release means 13 of the two ejection devices 1 can be contacted by the contact contours 35 (indirectly coupled via the synchronization shaft 17) at different contact positions 37, 38 with the two locking devices 9 of the two ejection devices 1, wherein before unlocking both locking devices 9 are in a first contact position 37—representing the locking position 10.

In FIG. 12b, the right ejection means 6 is moved into the overpressure position 22, while the left ejection means 6 remains in the initial position. This can happen, for example, if one-sided pressure was applied to the movable furniture part 2. Without synchronization shaft 17, the left ejection device 1 could be released indirectly via the movable furniture part 2 if the right ejection device 1 is already unlocked and has been moved further in the opening direction 7, so that the left ejection means 6 is pulled along. In this embodiment, a synchronous unlocking is initiated, since when the right locking device 9 is unlocked by the synchronization shaft 17, the left locking device 9 is also unlocked.

This situation is illustrated in FIG. 12c, wherein in the right ejection device 1 the lever 14 is connected to the locking device 9 via a second contact position 38, whereas the left lever 14 remains in the first contact position 37. The second contact position 38 is suitable, due to the shape or geometry of the lever 14 in interaction with the locking device 9, to cause unlocking.

FIGS. 12d and 12e show the transition of both locking devices 9 into the unlocked state to release the two ejection means 6 or the control devices 12 involved, wherein the ejection means 6 are unlocked simultaneously in the opening direction 7 by the synchronization shaft 17.

Basically, the two ejection means 6 can be unlocked both by pulling (in the opening direction 7) and by pushing (in the closing direction 11). A specific position of the lever 14 can be used to unlock and synchronize the ejection devices 1.

FIG. 12f shows the state of the two ejection devices 1 after completion of the synchronization of the unlocking of the two locking devices 9, wherein an exemplary method for synchronizing the two ejection devices 1 can be explained as follows:
the release means 13 of the first and second ejection device 1 is moved into a closed position 3, wherein the at least two release means 13 contact the two locking devices 9 in the same contact position 37
the release means 13 of the first ejection device 1 is moved from the closed position 3 to the overpressure position 22 and from the overpressure position 22 back to the closed position 3, wherein the release means 13 of the first ejection device 1 contacts the locking device 9 of the first ejection device 1 at a contact position 38 that is separate from and modified from the first contact position 37, so that the locking device 9 is pivoted to activate the ejection means 6 of the first ejection device 1
the synchronization shaft transmits the pivoting movement of the locking device 9 of the first ejection device 1 to the locking device 9 of the second ejection device 1, wherein the locking device 9 of the second ejection device 1 is pivoted and releases the ejection means 6 of the second ejection device 1.

1. An ejection device for a movable furniture part for moving the movable furniture part from a closed position in the direction of an open position, comprising:
a housing,
an ejection means which is movable relative to the housing for transmitting force from the ejection device to the movable furniture part in the opening direction,
an energy storage device for applying force to the ejection means, and
a locking device for inhibiting movement of the ejection means in a locking position of the locking device in the direction of the open position,
wherein the ejection means comprises at least one release means separate from the locking device and the ejection means for contacting and/or interacting with the locking device, wherein the at least one release means is arranged on the ejection means.

2. The ejection device according to claim 1, further comprising a control device for transmitting force from the energy storage device to the ejection means, wherein preferably movement of the control device in the direction of the open position can be inhibited in the locking position of the locking device.

3. The ejection device according to claim 1, wherein the at least one release means is arranged directly on the ejection means, at least in regions within the ejection means and/or directly between the ejection means and a housing side wall of the housing.

4. The ejection device according to claim 1, wherein the at least one release means comprises a damping device, preferably a rotary damper, with which a rotation of the at least one release means about a rotation axis, preferably arranged on the ejection means, can be damped.

5. The ejection device according to claim 4, wherein the damping device forms a time element for contacting the locking device by means of the at least one release means, preferably as push-through protection for the ejection means.

6. The ejection device according to claim 4, wherein the at least one damping device is arranged, preferably directly, on and/or in the ejection means.

7. The ejection device according to claim 1, wherein the at least one release means is configured as a lever pivotable and/or force-actuated relative to the ejection means.

8. The ejection device according to claim 1, wherein the locking device can be unlocked via the ejection means both by applying pressure to the ejection means in the closing direction and by pulling on the ejection means in the opening direction, so that the ejection means can be released in the opening direction.

9. The ejection device according to claim 1, wherein the at least one release means is pivotably arranged on the ejection device and comprises a contact contour, in particular a contact surface, with which the locking device can be contacted in two separate contact positions, wherein it is preferably provided that the contact contour is curved and/or has a knurling.

10. A piece of furniture comprising a furniture body, at least one furniture part movable relative to the furniture body and the ejection device according to claim 1.

11. The piece of furniture according to claim 10, wherein the ejection device is one of at least two, preferably substantially mirror-symmetrical, ejection devices arranged on the furniture body for ejecting the movable furniture part.

12. A method for operating an ejection device according to claim 1, the method comprising:
starting from the open position, the ejection means is moved together with a control device and the at least one release means into the closed position,
starting from the closed position, the ejection means is moved together with the at least one release means into an overpressure position, and
the ejection means is moved back from the overpressure position in the direction of the closed position together with the at least one release means, wherein the at least one release means is pivoted in a direction orthogonal to the opening direction, in particular in a damped manner, so that the at least one release means contacts the locking device in the closed position and movement of the ejection means together with the control device and the at least one release means in the direction of the open position is inhibited by means of the locking device in the locking position.

13. The method according to claim 12 for ejecting a movable furniture part from a closed position in the direction of an open position relative to a furniture body by means of two ejection devices, wherein:
a first ejection means of a first ejection device of the two ejection devices is moved from the closed position into an overpressure position by pressure on the movable furniture part in the closing direction,
a first energy storage device of the first ejection device moves the first ejection means in the direction of the open position, so that the first locking device of the first ejection device is unlocked and the first ejection means is moved in the opening direction,
the movable furniture part is also moved by means of the first ejection means in the opening direction, so that a second ejection means of a second ejection device of the two ejection devices is also moved in the opening direction,
a second locking device of the second ejection device is unlocked by pulling on the second ejection means in the opening direction, in particular without a synchronization shaft, so that a second energy storage device of the second ejection device transmits force to the second ejection means and the movable furniture part is subjected to a force in the direction of the open position.

14. The method according to claim 13 for synchronizing the two ejection devices via a synchronization shaft, wherein:
at least one release means of the first and a second ejection device is moved into a closed position, wherein the at least two release means contact the two locking devices in the same contact position,
the at least one release means of the first ejection device is moved from a closed position to an overpressure position and from the overpressure position back to the closed position, wherein the at least one release means of the first ejection device contacts the locking device of the first ejection device at a contact position that is separate from and changed with respect to the first contact position, so that the locking device is pivoted to activate the ejection means of the first ejection device, and
the synchronizing shaft transmits the pivoting movement of the locking device of the first ejection device to the locking device of the second ejection device, wherein the locking device of the second ejection device is pivoted and releases the ejection means of the second ejection device.
